(19) United States
(12) Patent Application Publication
(10) Pub. No.: US 2014/0230259 A1
(43) Pub. Date: Aug. 21, 2014

(54) DISTANCE MEASURING APPARATUS

(71) Applicant: TiBao Zhang, Shen-Yang (CN)

(72) Inventor: TiBao Zhang, Shen-Yang (CN)

(21) Appl. No.: 13/769,587

(22) Filed: Feb. 18, 2013

(51) Int. Cl. G01B 3/08

(52) U.S. Cl. CPC G01B 3/08
USPC 33/427

(57) ABSTRACT

A distance measuring apparatus may include a body, a push button having a pointer, a graduation and a receiving space to receive a measuring unit. The measuring unit may further include a measuring gap. Likewise, the push button is coupled with the measuring unit, so the user can move the measuring unit out from the receiving space by sliding the push button up/down. The pointer may include a magnifier so that the player can more clearly see the number on the graduation. In another embodiment, the measuring unit can be U-shaped with a pair of sharpened front ends, where the measuring unit can also be used as a divot.

### FIELD OF THE INVENTION

The present invention relates to a distance measuring device, and more particularly to a portable distance measuring device that is easy to use and can be used in golf.

### BACKGROUND OF THE INVENTION

Golf is an outdoor sport and entertaining activity, using different golf clubs to hit the ball into a series of holes on a golf course according to certain rules. The popularity of golf as a recreational and sporting activity has been increasing recently because it is suitable for almost everyone regardless of age, sex and physical condition. Golf is also known as a “gentleman's game” because it emphasizes on proper and civilized manners.

Since the winner of the game is the player who uses the fewest number of strokes, the distance between the ball and designated hole is critical for the player to apply appropriate strength to hit the ball, so that the placement of the ball can be as close as possible to the designated hole, or even directly falling into the designated hole. This is especially important to the beginner of golf, however, currently the distance measuring device is complicated such as electronic devices or GPS, which is more expensive and not convenient to use. Therefore, there remains a need for a new and improved distance measuring device used in golf which is easy to use, portable and less expensive.

### SUMMARY OF THE INVENTION

It is an object of the present invention to provide a distance measuring apparatus that is easy to user, portable and less expensive. The distance measuring apparatus can be used in golf to measure the distance between the user's current position and greens.

It is another object of the present invention to provide a distance measuring apparatus to measure the distance between the user's current position and a flagstick on a putting green using simple mathematics for triangulation.

It is a further object of the present invention to provide a distance measuring apparatus including a receiving space to receive a measuring unit to minimize the size of the measuring apparatus.

It is still a further object of the present invention to a distance measuring apparatus that can also be used as a divot.

In one aspect, a distance measuring apparatus may include a body, a push button having a pointer, a graduation and a receiving space to receive a measuring unit. In one embodiment, the measuring unit may further include a measuring gap which can be used to align and enclose a vision of an object to measure the distance between the current position and the object. In another embodiment, the measuring unit can be U-shaped that can be used as a divot. In a further embodiment, the pointer may include a magnifier so that the player can more clearly see the number on the graduation.

### BRIEF DESCRIPTION OF THE DRAWINGS

FIG. 1 is a mathematic principle used in the present invention.

FIG. 2 is one embodiment of a distance measuring device in the present invention.

FIG. 2a is one embodiment of a distance measuring device with a distance measuring unit in the present invention.

FIG. 3 is another embodiment of a distance measuring device in the present invention.

FIG. 3a is another embodiment of a distance measuring device with a distance measuring unit in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As previously stated, since the winner of golf is the player who uses the fewest number of strokes, the distance between the ball and designated hole is critical for the player to apply appropriate strength to hit the ball, so that the placement of the ball can be as close as possible to the designated hole, or even directly falling into the designated hole. This is especially important to the beginner of golf, however, currently the distance measuring device is complicated such as electronic devices or GPS, which is either more expensive or not convenient to use.

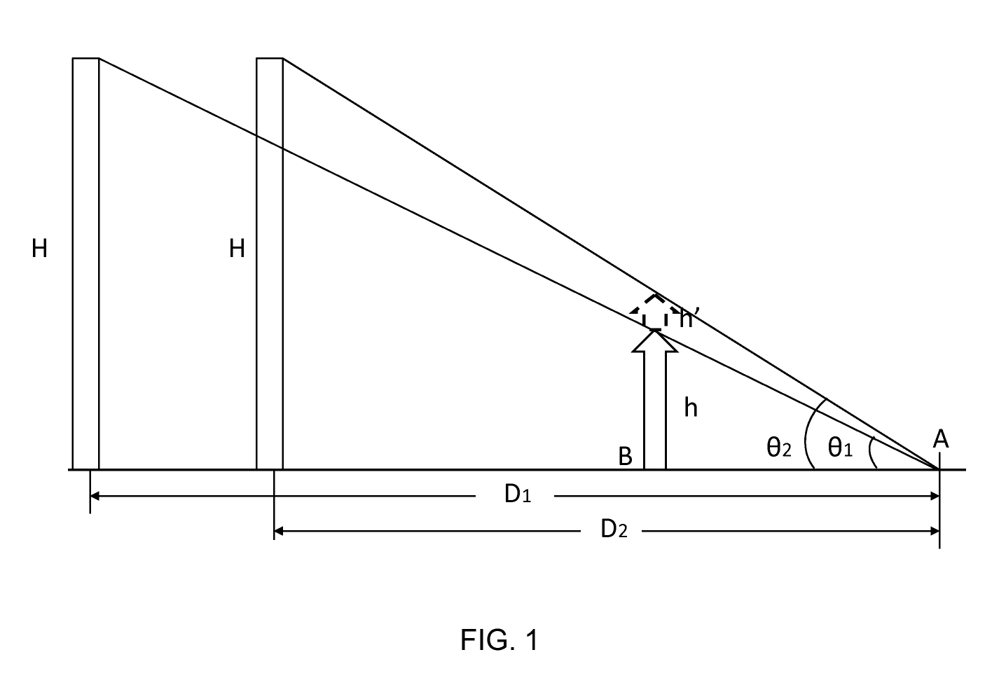

FIG. 1 shows simple mathematics for triangulation. When a person stands on point A to measure a tree with the height H, and if the elevation angle from point A to look at the very top of the tree is θ₁, the distance D₁ from point A to the tree can be obtained by a simple mathematic equation: H/h=D₁/D_{AB}, and D₁ equals to H*D_{AB}/h, where h is the height of a measuring device and D_{AB} is the distance between the person's current position (point A) to the measuring device. Assuming that the tree is closer to point A as shown in FIG. 1, the distance D₂ can be obtained by a similar equation H/(h+h′)=D₂/D_{AB}, where h′ is an additional height of the measuring device to align with the top of the tree with the same height H. Thus, D₂ equals H*D_{AB}/(h+h′). It is noted that the elevation angle θ₂ is greater than θ₁ because the tree is closer and the measuring device has to be longer to align with the top of the tree. According to basic mathematic calculation, D₁ is greater than tan D₂ because (h+h′) is greater than h, which agrees with the illustration in FIG. 1. In a nutshell, if the height (H) of the tree is known, the distance between the observer to the tree can be obtained if the height of the measuring device (h) and the distance between the observer's current position and the measuring device (D_{AB}) are also known.

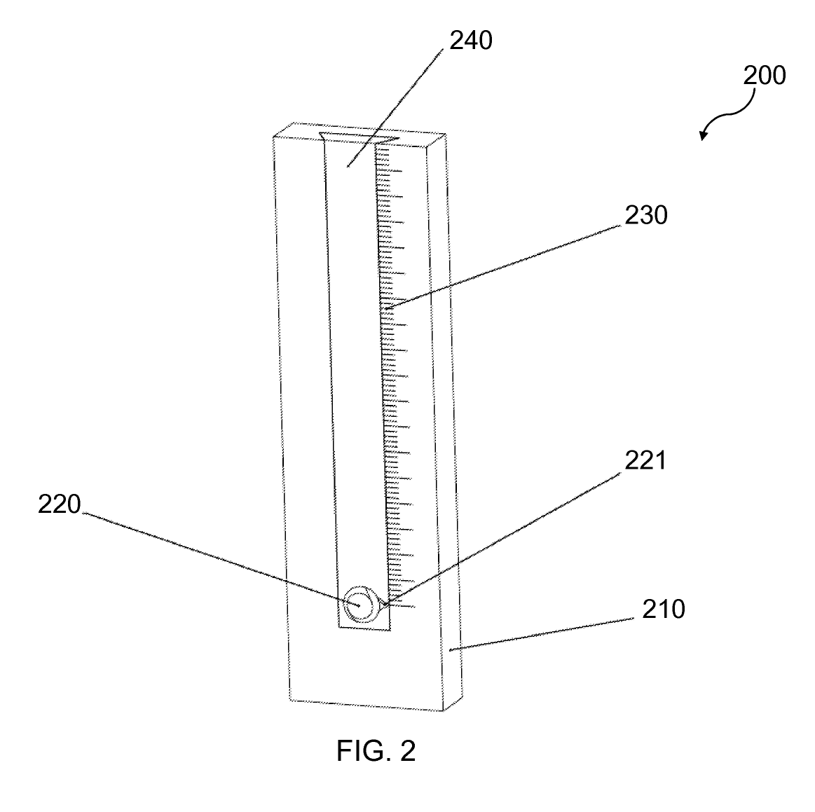

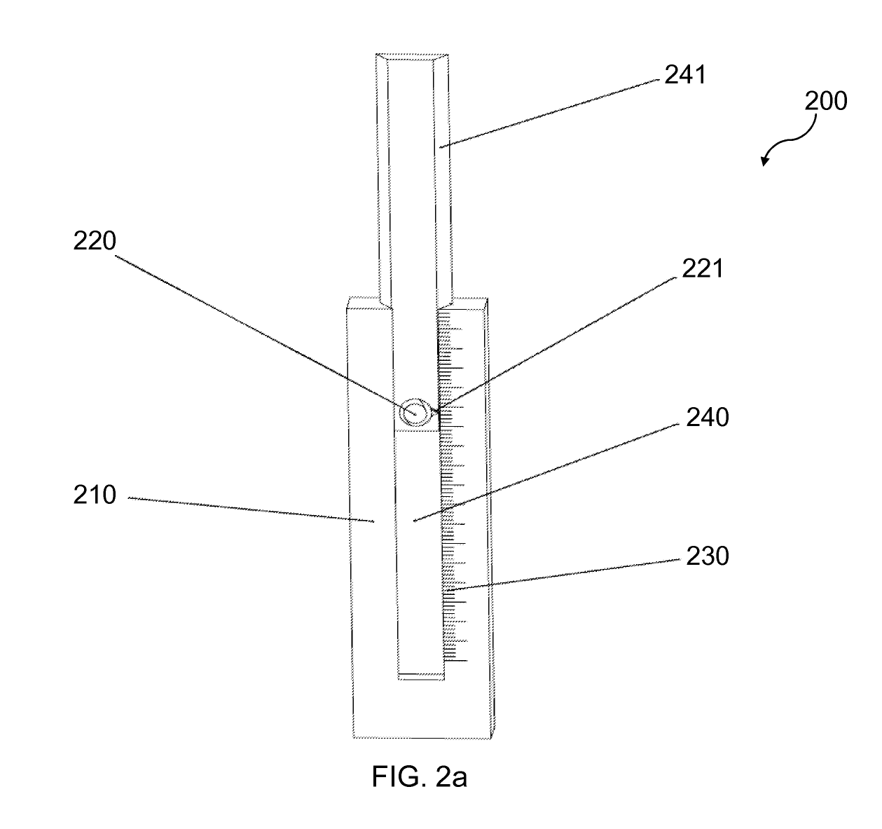

Referring to FIGS. 2 and 2a, a distance measuring apparatus 200 may include a body 210, a push button 220 having a pointer 221, a graduation 230 and a receiving space 240 to receive a measuring unit 241. The push button 220 is coupled with the measuring unit 241, so the user can move the measuring unit 241 out from the receiving space 240 by sliding the push button 220 up/down. Referring to FIG. 1, if a golf player would like to measure the distance from his/her current position (point A) to a flagstick at the putting green with the distance measuring apparatus 200, the user can stand at point A, aligning the apparatus 200 with the vision of the flagstick and sliding the push button 220 up until the top of the measuring element 241 aligns with the top of the vision of the flagstick. At this time, the pointer 221 would point at a corresponding number on the graduation 230, which is the distance between the player's current position and the flagstick at the putting green. It is advantageous that the measuring unit 241 can be fully received in the receiving space 240, so the measuring apparatus 200 is becomes more compact and portable. It is noted that a securing unit (not shown) is disposed inside the measuring apparatus 200 to secure the position of the pointer 221.

Still referring to FIG. 1, if the distance between the player and flagstick is D₁, D₁ can be read from the distance measuring apparatus 200 when the player at point A aligns the top of the measuring unit 241 with the top of the vision of the flagstick. Similarly, when the flagstick is closer, the distance between the player and flagstick is D₂, which can also be read from the distance measuring apparatus 200 when the player at point A aligns the top of the measuring unit 241 with the top of the vision of the flagstick. It is noted that the elevation angle θ₂ is greater than θ₁ when the flagstick is closer, so the player has to use a longer measuring unit 241 to align with the vision of the flagstick.

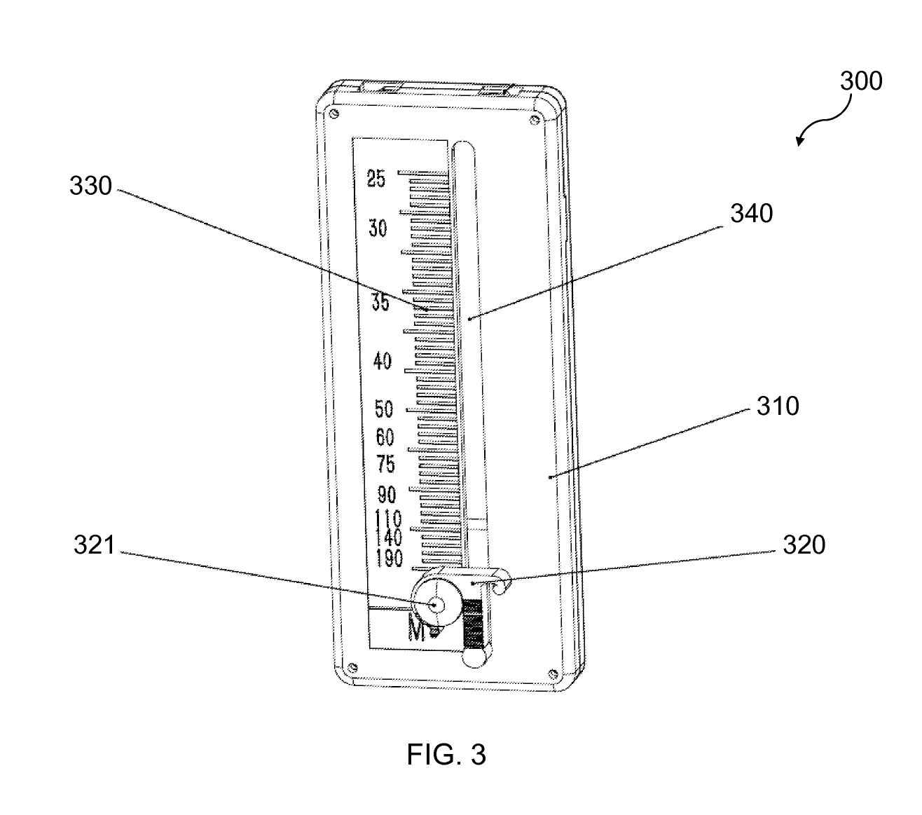

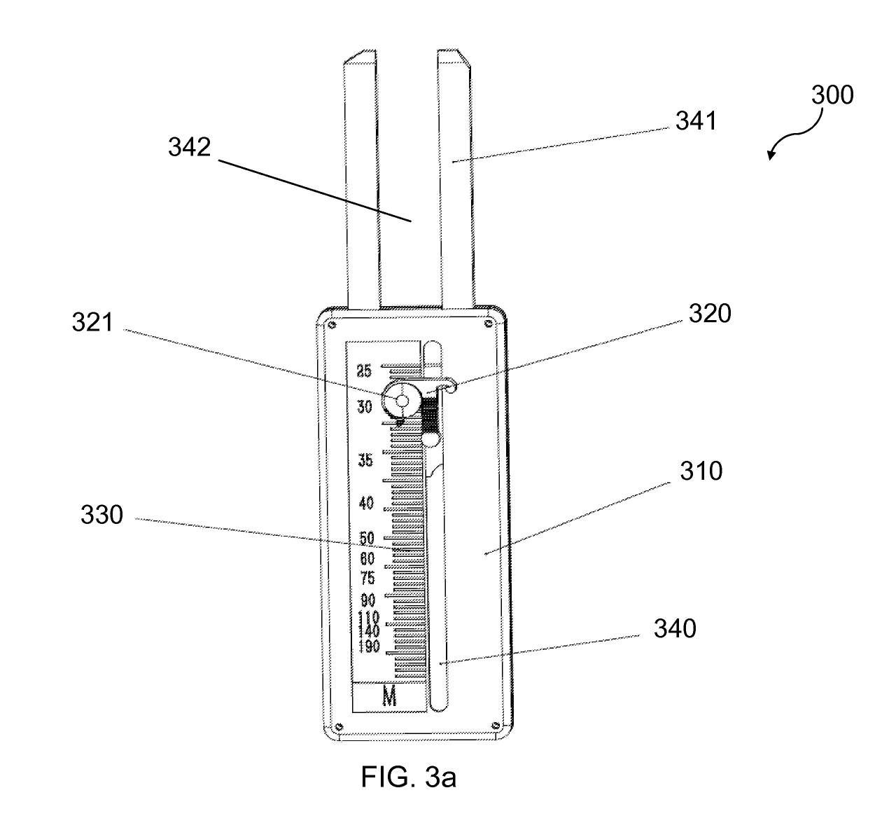

Referring to FIGS. 3 and 3a, a distance measuring apparatus 300 may include a body 310, a push button 320 having a pointer 321, a graduation 330 and a receiving space 340 to receive a measuring unit 341. The measuring unit 341 may further include a measuring gap 342. Likewise, the push button 320 is coupled with the measuring unit 341, so the user can move the measuring unit 341 out from the receiving space 340 by sliding the push button 320 up/down. Referring again to FIG. 1, if a golf player would like to measure the distance from his/her current position (point A) to a flagstick at the putting green with the distance measuring apparatus 300, the user can stand at point A, aligning the apparatus 300 with the flagstick and sliding the push button 320 up until the measuring gap 342 encloses the entire vision of the flagstick. At this time, the pointer 321 would point at a corresponding number on the graduation 330, which is the distance between the player's current position and the flagstick at the putting green. The pointer 321 may include a magnifier so that the player can more clearly see the number on the graduation 330. In another embodiment, the measuring unit 341 can be U-shaped with a pair of sharpened front ends, where the measuring unit 341 can also be used as a divot. Also, the measuring unit 341 can be fully received in the receiving space 340, so the measuring apparatus 300 is becomes more compact and portable. It is noted that a securing unit (not shown) is disposed inside the measuring apparatus 300 to secure the position of the pointer 321.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A distance measuring apparatus comprising a body, a push button having a pointer, a graduation and a receiving space to receive a measuring unit, wherein the push button is coupled with the measuring unit to slide the measuring unit in the receiving space, and when a top portion of the measuring unit is slid to align with a vision of an object, the pointer points at a corresponding number on the graduation, which is distance between the object and the distance measuring apparatus.

2. The distance measuring apparatus of claim 1, wherein the pointer includes a magnifier.

3. The distance measuring apparatus of claim 1, wherein the measuring unit is U-shaped with a pair of sharpened ends.

4. The distance measuring apparatus of claim 3, wherein the distance measuring apparatus is used as a divot.

5. The distance measuring apparatus of claim 3, wherein the U-shaped measuring unit has a measuring gap which is used to align and enclose the vision of the object.

6. The distance measuring apparatus of claim 1, wherein the corresponding number on the graduation indicating the distance between the object and the distance measuring apparatus is obtained through mathematic triangulation.

7. The distance measuring apparatus of claim 1, wherein the distance measuring apparatus is used in golf to measure distance between a player's current position and a putting green.

8. The distance measuring apparatus of claim 1, further comprising a securing unit to secure the pointer's position when it points to corresponding number on the graduation.
